(19) United States
(12) Patent Application Publication
(10) Pub. No.: US 2026/0309416 A1
(43) Pub. Date: Oct. 8, 2026

(54) DRYING FACILITY INCORPORATING A HEAT RECOVERY AND DRYING STEAM GENERATION SYSTEM, AND DRYING METHOD WHICH MAKES USE OF SUCH A FACILITY

(71) Applicant: FRANCE EVAPORATION, NOYELLES-LES-SECLIN (FR)

(72) Inventors: Olivier DEHAY, NOYELLES-LES-SECLIN (FR); Alexandre NICOT, NOYELLES-LES-SECLIN (FR); Sébastien DEHAY, NOYELLES-LES-SECLIN (FR)

(73) Assignee: FRANCE EVAPORATION, NOYELLES-LES-SECLIN (FR)

(21) Appl. No.: 19/638,460

(22) Filed: Apr. 3, 2026

(30) Foreign Application Priority Data
Apr. 3, 2025 (FR) FR2503510

(51) Int. Cl. F26B 21/45; F26B 23/00

(52) U.S. Cl. CPC F26B 21/452; F26B 23/004

(57) ABSTRACT

A drying facility including a dryer having a drying enclosure and a drying steam inlet (E2), a heat recovery and drying steam generation system including a mechanical steam compression system, having one or more mechanical compression stages, each having a compressor (Cop) for compressing low-pressure steam into high-pressure steam which is conveyed to the drying steam inlet (E2) of the drying enclosure of the dryer.

This disclosure concerns a drying facility providing a heat recovery and drying steam generation system, as well as a drying method which makes use of such a facility.

### TECHNICAL FIELD

This disclosure relates to the field of drying facilities, typically industrial, for drying food or non-food products, the products being in a liquid, paste, powder, or solid form.

### BACKGROUND

Examples of dryer technologies that are known in drying facilities of the prior art are, in particular: the silo dryer, tunnel dryer, rotary drum dryer, fluid bed dryer, flash dryer, drying oven and/or furnace, belt dryer, spray tower, etc.

These various technologies are energy-intensive and rely on the generation of steam heated to a temperature above ambient temperature and typically determined according to the maximum acceptable temperature for the products. Often, this high-temperature steam is obtained by providing heat produced by combustion of a fuel, for example gas, oil, or even a coarse fuel, which generates a significant amount of the greenhouse gas CO₂.

Within the context of current environmental goals of reducing greenhouse gas emissions, the heat produced from electrical energy is preferred, particularly when this energy is obtained at a low CO₂ production cost, for example by using renewable energy sources or even nuclear energy.

In general, there is a need for drying facilities, typically industrial, which operate using electrical energy and at optimized efficiency, thereby reducing electricity consumption compared to known drying facilities.

### SUMMARY

This disclosure improves the situation.

A drying facility is proposed comprising:
/A/ a dryer having a drying enclosure and a drying steam inlet, the drying steam being configured to exchange heat indirectly with products to be dried within the drying enclosure, through a wall according to a first possibility, or alternatively the drying steam transfers its heat to a drying air supplied to the drying enclosure in order to dry the products by direct contact between the products and the drying air according to a second possibility, and a waste steam outlet for a waste steam flow which comes from drying the products, the waste steam being expressed from the products,
/B/ a heat recovery and drying steam generation system, comprising:
   a pipe for recovering the waste steam flow,
   a heat recovery assembly which is fed the waste steam flow conveyed by the pipe, comprising an inlet for the waste steam flow conveyed by the pipe and a condensate outlet for a condensate and an outlet for non-condensables,
   a steam generation system comprising an inlet for a liquid to be vaporized and ensuring the vaporization of said liquid which is then discharged via a low-pressure steam outlet, the vaporization of said liquid being achieved in whole or in part by the heat recovered from the waste steam flow by the heat recovery assembly;
   a mechanical steam compression system, comprising one or more mechanical compression stages, each having a compressor ensuring the compression of the low-pressure steam into a high-pressure steam which is conveyed to the drying steam inlet of the drying enclosure of the dryer.

The features described in the following paragraphs may optionally be implemented, independently or in combination.

According to one embodiment, the liquid to be vaporized comes in whole or in part from a condensate resulting from condensation of the drying steam that has transferred its heat to the products through the wall according to the first possibility, or alternatively the liquid to be vaporized comes in whole or in part from a condensate resulting from the condensation of drying steam that has transferred its heat to the drying air according to the second possibility, a pipe conveying the condensate to the steam generation system.

According to one embodiment, the compression stages provide a compression ratio that is greater than 10, or even 20, for example between 10 and 50.

According to one embodiment, the facility comprises a control and regulation unit for the compression system, comprising a microprocessor, memory, and a set of instructions configured to control the frequency and/or speed of some or all of the compressors, in order to provide several different operating ranges of the dryer, and to control at least one control valve of at least one bypass loop ensuring the recirculation of the drying steam from the upstream compressor(s) while ensuring a minimum flow rate in the compressor(s).

According to one embodiment, the condensate that comes from the condensation of waste steam is a liquid that is distinct from the liquid to be vaporized. The heat recovery assembly and the steam generation system are formed by a falling-film heat exchanger comprising, within a sealed enclosure:
a set of vertical tubes having upper and lower openings, the vertical tubes extending in parallel within a sealed compartment of the sealed enclosure,
an inlet for the waste steam flow into the sealed compartment, configured such that the waste steam flow exchanges heat with the outer surfaces of the vertical tubes,
the liquid to be vaporized, coming from a supply source and/or from condensation of the drying steam, and fed into an upstream upper chamber that is open to the upper openings of the tubes, such that gravity causes the liquid to flow inside the tubes, vaporizing a portion of the liquid due to the transfer of heat from the waste steam, and an unvaporized portion of the liquid exiting through the lower openings of the tubes and recovered in a downstream lower chamber;
a recirculation pump which recirculates the liquid recovered in the downstream chamber, recycling it into the upstream chamber;
an outlet for the low-pressure steam generated inside the tubes.

According to one embodiment, the heat recovery assembly comprises a mixing condenser which has a condensation chamber within which the waste steam flow condenses into condensate by a direct heat exchange with the condensate, which is collected at the bottom via an outlet from the mixing condenser, cooled outside the condenser, and recycled for spraying or misting at the top of the condensation chamber via an inlet into the condensation chamber.

According to one embodiment, the condensate is a liquid that is distinct from the liquid to be vaporized, the liquid to be vaporized and the waste steam condensate not being mixed. The heat recovery assembly includes a heat transfer device comprising at least one heat exchanger and/or a heat pump system, configured to: extract heat from the condensate and cool it before recirculating the cooled condensate to the condenser, and transfer the heat extracted from the condensate to the liquid to be vaporized in order to reheat it.

According to one embodiment, the steam generation system comprises a vaporization device configured to spray and partially vaporize, into the low-pressure steam, the liquid to be vaporized which has been heated by the heat extracted from the condensate in a vaporization enclosure via an inlet to the vaporization enclosure, by an abrupt drop in the pressure of the liquid. A portion of the liquid to be vaporized is recovered from the bottom of the vaporization enclosure via an outlet.

According to one embodiment, the heat transfer device includes the heat exchanger which comprises:
a primary side, through which the waste steam condensate flows as it recirculates from the outlet of the mixing condenser to the inlet of the mixing condenser,
a secondary side, through which the liquid to be vaporized flows, recirculated from the outlet in the bottom of the vaporization enclosure to the inlet of the vaporization enclosure,
   and wherein the heat transfer occurs through a wall of the heat exchanger.

According to one embodiment, the heat transfer device comprises a heat exchanger and a heat pump,
the heat exchanger comprising:
   a primary side, through which the condensate is recirculated from the outlet of the mixing condenser to the inlet of the mixing condenser,
   a secondary side, through which a loop of recirculated transfer fluid circulates,
and wherein the heat transfer occurs through a wall of the heat exchanger,
   the heat pump comprising a coolant circuit including an evaporator and a condenser, the condenser extracting heat from the recirculated transfer fluid, and the condenser transferring heat to the liquid to be vaporized that is recirculated from the outlet in the bottom of the vaporization enclosure to the inlet of the vaporization enclosure.

According to one embodiment, the heat transfer device comprises a heat pump comprising a coolant circuit which includes:
an evaporator extracting heat from the condensate that is recirculated from the outlet of the mixing condenser to the inlet of the mixing condenser, and
a condenser transferring heat to the liquid to be vaporized that is recirculated from the outlet in the bottom of the vaporization enclosure to the inlet of the vaporization enclosure.

In particular, the liquid to be vaporized, heated by the heat from the condensate recovered at the bottom outlet of the mixing condenser, is sprayed and partially vaporized into the low-pressure steam in a vaporization enclosure via an inlet, by means of a sudden pressure drop. A portion of the liquid to be vaporized is recovered at the bottom of the vaporization enclosure via an outlet and recycled back to the inlet of the mixing condenser.

According to one embodiment, the heat recovery assembly comprises a plate heat exchanger and a heat pump, and the steam generation system comprises a vaporization device,
wherein:
   the plate heat exchanger comprises:
      a primary side, through which the waste steam flow circulates,
      a secondary side, through which a transfer fluid from a loop of circulating transfer fluid circulates,
the heat exchanger being configured to transfer heat from the primary side, by extracting heat from the waste steam flow, to the secondary side, in order to heat the transfer fluid by means of one or more plates of the exchanger,
and wherein the heat pump comprises a coolant circuit including an evaporator that extracts heat from the transfer fluid of the circulation loop and a condenser that transfers heat to the liquid to be vaporized,
and wherein the vaporization device comprises a vaporization chamber having an inlet for the heated liquid to be vaporized which is sprayed and partially vaporized in the vaporization chamber by a sudden drop in the pressure of the liquid, the unvaporized portion of the liquid to be vaporized then falling to the bottom of the chamber and being recovered via an outlet ensuring recirculation of the liquid to be vaporized back to the condenser of the heat pump.

According to one embodiment, the steam generation system has a heat exchanger and a vaporization device,
and wherein the heat exchanger is a spray-cooled tube heat exchanger comprising, within a sealed enclosure:
   a set of horizontal tubes having lateral openings at their ends, the horizontal tubes extending into a sealed compartment of the sealed enclosure,
   an inlet for the waste steam flow into an upstream chamber, arranged on one side of the sealed compartment and leading into the interior of the tubes, the upstream chamber being configured such that the waste steam flow passes through the tubes, exchanging heat with the inner surfaces of the tubes and condensing into a condensate, and a downstream collection chamber, which is open to the interior of the tubes, arranged on a second side of the sealed compartment, the downstream chamber being configured to collect the condensate and having the outlet for condensates and the outlet for non-condensables,
and wherein the compartment of the spray-cooled tube heat exchanger includes an inlet for the liquid to be vaporized and a means for spraying the liquid to be vaporized onto the outer surfaces of the horizontal tubes in the compartment, configured to heat the liquid to be vaporized, the sealed compartment having an outlet for the heated liquid to be vaporized,
and wherein the vaporization device comprises a vaporization chamber having an inlet for the heated liquid to be vaporized, which is sprayed and partially vaporized in the vaporization chamber by a sudden pressure drop, the unvaporized liquid to be vaporized falling to the bottom of the vaporization chamber and being recovered via an outlet ensuring the recirculation of the liquid to be vaporized back to the inlet to the compartment of the spray-cooled tube heat exchanger.

According to one embodiment, wherein the steam generation system has a heat exchanger which is a spray-cooled tube heat exchanger, a heat pump, and a vaporization device, and wherein the spray-cooled heat exchanger comprises, within a sealed enclosure:
a set of horizontal tubes having lateral openings at their ends, the horizontal tubes extending into a sealed compartment of the sealed enclosure,
an inlet for the waste steam flow into an upstream chamber arranged on one side of the sealed compartment and open to the interior of the tubes, the upstream chamber being configured such that the waste steam flow passes through the tubes, exchanging heat with the inner surfaces of the tubes and condensing into a condensate, and a downstream chamber, open to the interior of the tubes, arranged on a second side of the sealed compartment, the downstream chamber being configured to collect the condensate and having the outlet for condensates and the outlet for non-condensables, and wherein the compartment of the heat exchanger has an inlet for a transfer liquid or transfer fluid and a means for spraying a liquid onto the outer surfaces of the horizontal tubes in the compartment, configured to heat the transfer fluid, the sealed compartment having an outlet for the heated transfer fluid,
   and wherein the heat pump comprises a coolant circuit including an evaporator and a condenser, the evaporator being configured to extract heat from the transfer fluid which is then recirculated to the compartment's inlet for the transfer fluid, the condenser of the heat pump transferring heat to the liquid to be vaporized,
   and wherein the vaporization device comprises a vaporization chamber having an inlet for the heated liquid to be vaporized, which is sprayed and partially vaporized in the vaporization chamber by a sudden drop in the pressure of the liquid, the unvaporized liquid to be vaporized falling to the bottom of the vaporization enclosure and being recovered via an outlet that ensures the recirculation of the liquid to be vaporized back to the condenser of the heat pump.

According to the first possibility, the inlet for the drying steam is configured to ensure indirect drying of the products, through the wall of the drying enclosure.

According to the second possibility, the inlet for the drying steam is configured to heat air, via the wall, in the drying air supplied to the drying enclosure, in order to heat the products in the drying enclosure by direct contact between the drying air and the products.

According to one embodiment, the dryer is selected among:
a spray tower for which the drying enclosure is provided with a system for spraying a suspension to be dried having an inlet for drying air intended to be mixed with the products to be sprayed,
a rotary dryer comprising a rotating drum that receives the products internally, configured to ensure that the products are stirred during drying and that drying air circulates inside the enclosure containing the products,
a belt dryer comprising a conveyor belt supporting the products and ensuring the advancement of the products through the drying enclosure,
a flash dryer with an inlet at the base of a column for the products to be dried, the products being dispersed by an upward flow of drying air in the column which carries the products along,
a fluid bed dryer comprising, in the drying enclosure, a distributor plate which the drying air flows through, ensuring the creation of a fluid bed for the products.

According to a second aspect, this disclosure relates to a method of drying which makes use of a drying facility according to this disclosure, wherein the heat recovery and compressed steam generation facility recovers waste steam which is at a temperature between 10° C. and 150° C., and generates heating steam at a temperature between 80° C. and 220° C.

### BRIEF DESCRIPTION OF DRAWINGS

Other features, details and advantages will become apparent from reading the detailed description below, and from analyzing the accompanying drawings, in which:

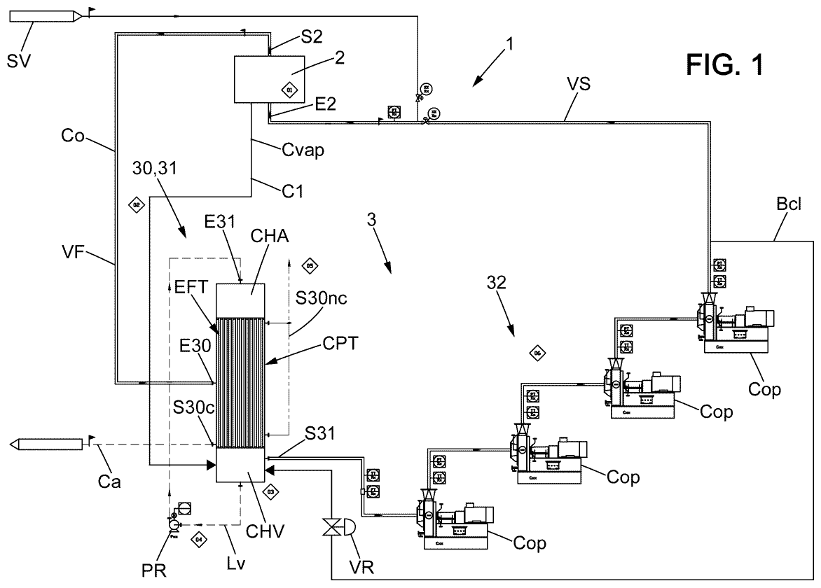

### FIG. 1

FIG. 1 shows a facility according to this disclosure, comprising a dryer having a drying steam inlet configured to exchange heat indirectly with products to be dried in the drying enclosure, in order to dry them, and a waste steam outlet for a flow of waste steam expressed by the products, and a heat recovery and drying steam generation system, comprising:
a pipe recovering the waste steam flow,
a heat recovery assembly fed by the waste steam flow conveyed by the pipe,
a steam generation system comprising an inlet for a liquid to be vaporized, and ensuring the vaporization of said liquid which is discharged via a low-pressure steam outlet, the vaporization of the liquid being at least partially achieved by the heat recovered from the waste steam flow by the heat recovery assembly,
a mechanical steam compression system comprising one or more mechanical compression stages, each comprising a compressor ensuring compression of the low-pressure steam into high-pressure steam which is conveyed to the drying steam inlet of the dryer,
   and notably wherein, according to a first embodiment, the heat recovery assembly and the steam generation system are formed by a single heat exchanger, which is a falling-film exchanger.

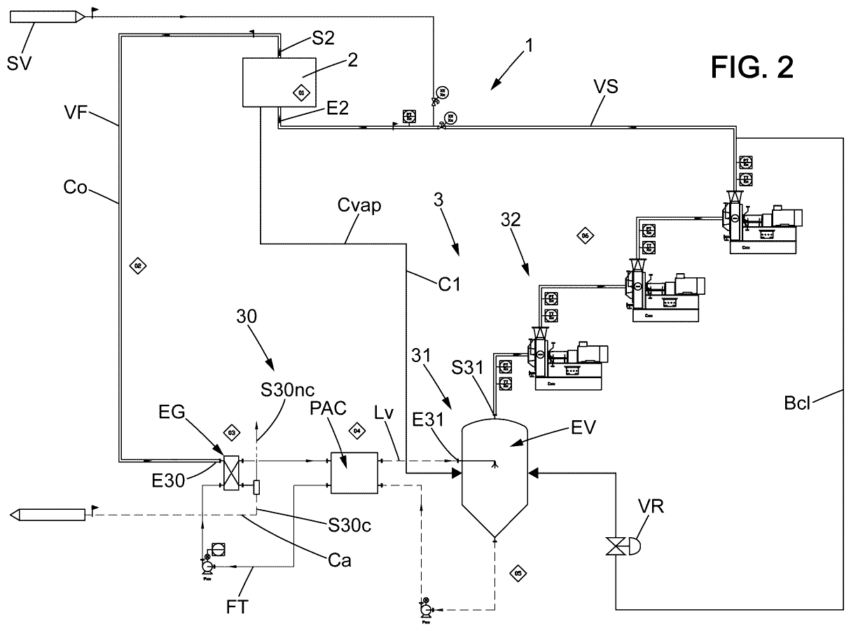

### FIG. 2

FIG. 2 is a facility according to the present disclosure in a second embodiment, in which, in particular, the heat recovery assembly includes a plate heat exchanger and a heat pump and the steam generation system comprises a flash steam vaporization device.

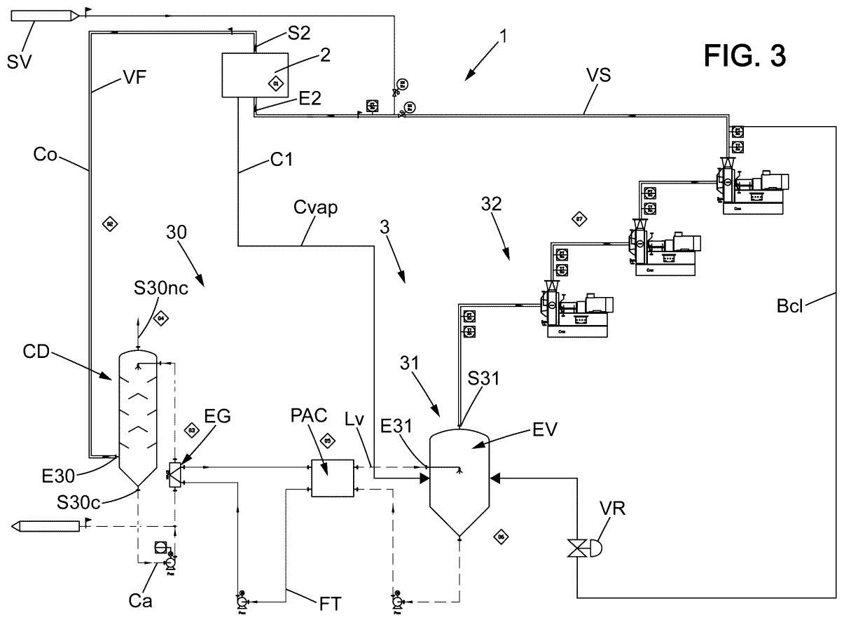

### FIG. 3

FIG. 3 is a facility according to this disclosure in a third embodiment, in which, in particular, the heat recovery assembly includes a condensing device, a plate heat exchanger, and a heat pump, and the steam generation system comprises a flash steam vaporization device.

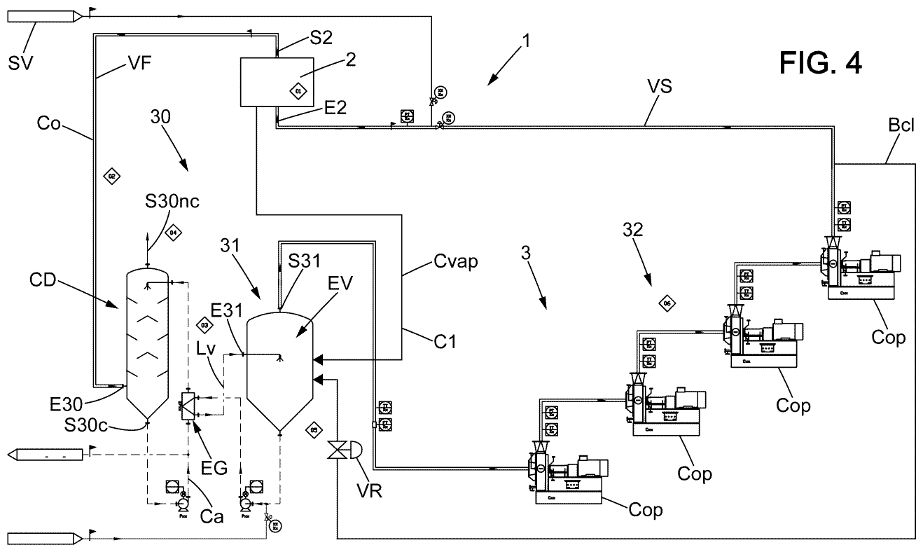

### FIG. 4

FIG. 4 is a facility according to this disclosure in a fourth embodiment, in which, in particular, the heat recovery assembly includes a condensation device and a plate heat exchanger and the steam generation system comprises a flash steam vaporization device.

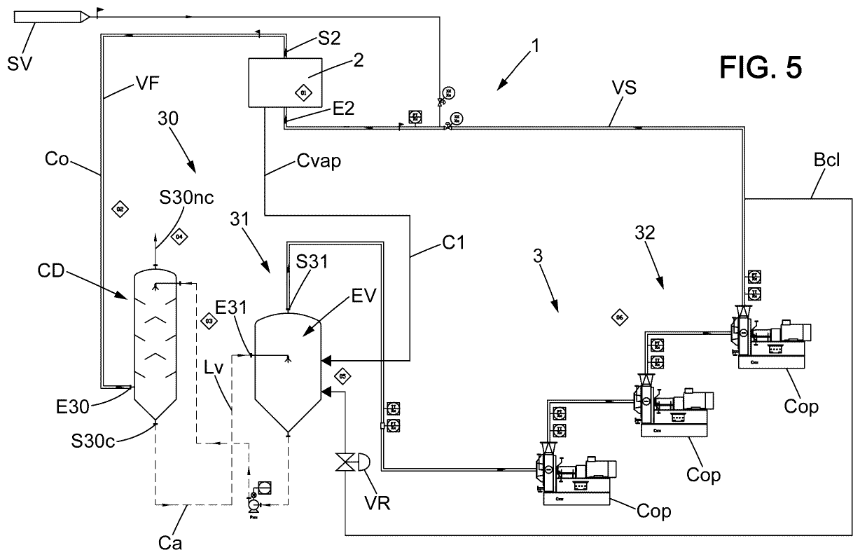

### FIG. 5

FIG. 5 is a facility according to this disclosure in a fifth embodiment, in which, in particular, the heat recovery assembly includes a condensation device and the steam generation system comprises a flash steam vaporization device.

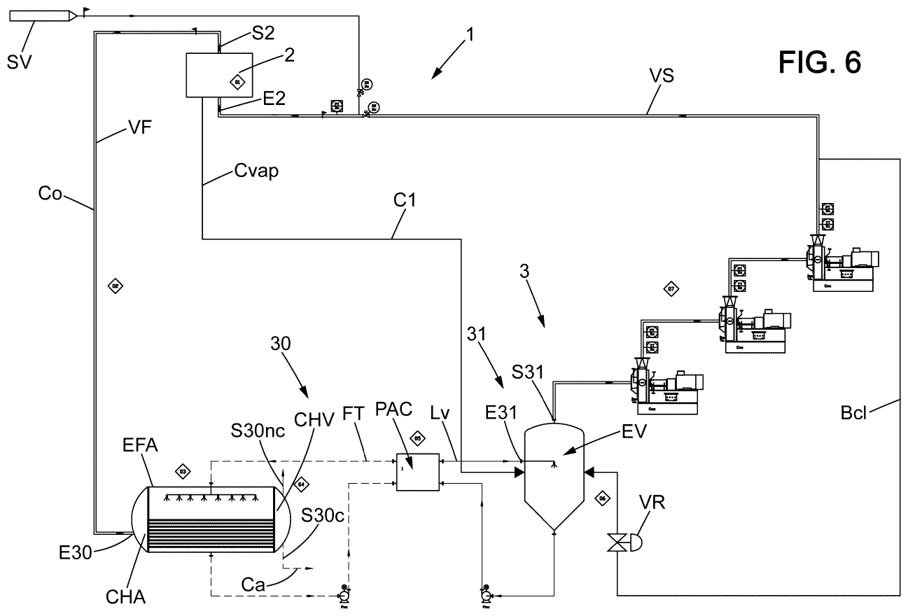

### FIG. 6

FIG. 6 is a facility according to this disclosure in a sixth embodiment, in which, in particular, the heat recovery assembly includes a spray-cooled tube heat exchanger and a heat pump, and the steam generation system comprises a flash steam vaporization device.

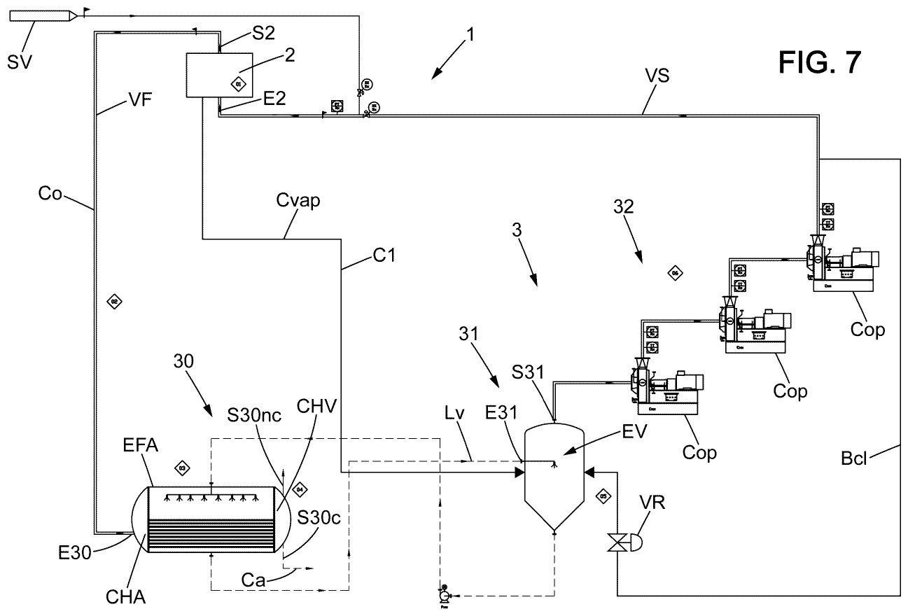

### FIG. 7

FIG. 7 is a facility according to this disclosure in a seventh embodiment, in which, in particular, the heat recovery assembly includes a spray-cooled tube heat exchanger and the steam generation system comprises a flash steam vaporization device.

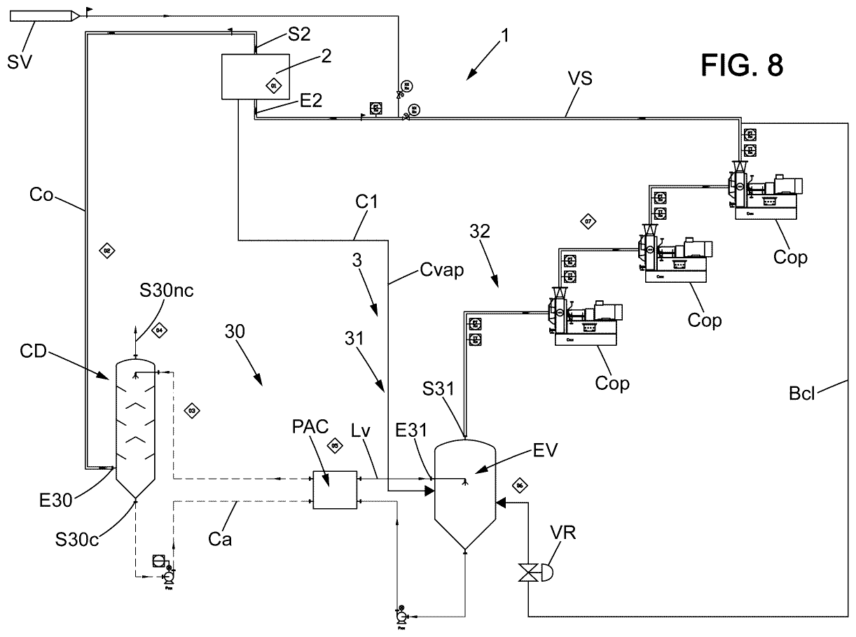

### FIG. 8

FIG. 8 is a facility according to this disclosure in an eighth embodiment, in which, in particular, the heat recovery assembly includes a condensation device and a heat pump, and the steam generation system comprises a flash-expansion vaporization device.

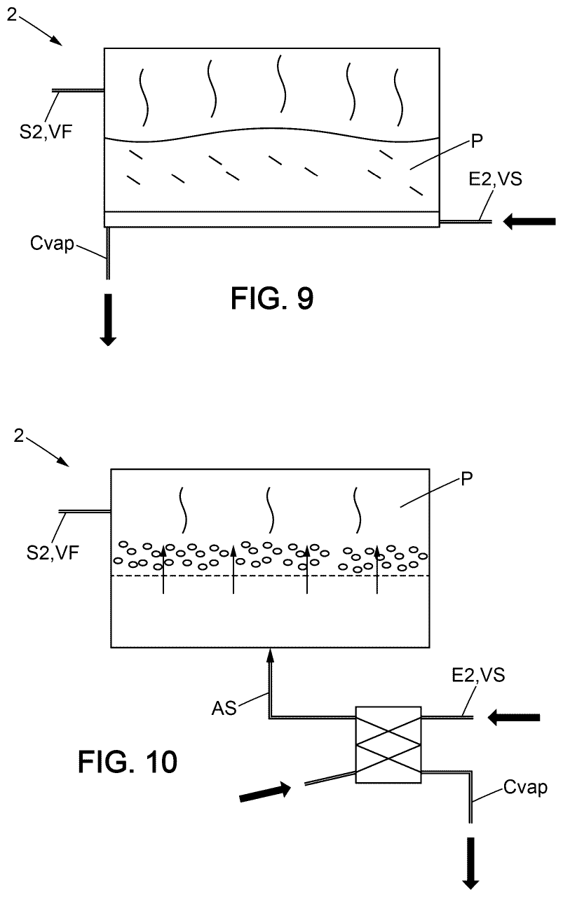

### FIG. 9

FIG. 9 is a schematic view of a dryer according to a first possibility, in which the drying steam circulates inside the wall of the drying enclosure containing the products to be dried, transferring its heat to the product through the enclosure wall. The condensate which comes from the condensation of the steam circulates in a pipe in order to be conveyed to the steam generation system for use as a liquid to be vaporized.

### FIG. 10

FIG. 10 is a schematic view of a dryer 2 according to a second possibility, in which the drying steam passes through a heat exchanger to heat cold (ambient) air into drying air. The drying air is then fed into the drying enclosure containing the products, heating them by direct contact between the drying air and the products. The condensate which comes from the condensation of the drying steam circulates, downstream of the exchanger, through a pipe to the steam generation system for use as a liquid to be vaporized.

### DETAILED DESCRIPTION

This disclosure relates to a drying facility 1 comprising:
/A/ a dryer 2 having a drying enclosure and comprising a drying steam inlet E2 configured to exchange heat indirectly with products to be dried within the drying enclosure, through a wall, in order to dry them according to a first possibility (in particular illustrated in FIG. 9); or alternatively, the drying steam inlet, the drying steam VS configured to heat, through a wall, a drying air AS according to a second possibility (in particular illustrated in FIG. 10), and a waste steam outlet S2 for a waste steam flow which comes from drying the products P, the waste steam VF being expressed from the products P,
/B/ a heat recovery and drying steam generation system 3 for which the object is to recover the heat contained in the waste steam and transfer it to the drying steam.

The heat recovery and steam generation system 3 comprises:
a pipe Co collecting the waste steam flow VF,
a heat recovery assembly 30 fed by the waste steam flow conveyed by the pipe Co, comprising an inlet E30 for the waste steam flow conveyed by the pipe and a condensate outlet S30c for a condensate Ca and an outlet for non-condensables s30nc,
a steam generation system 31 comprising an inlet E31 for a liquid to be vaporized Lv and ensuring the vaporization of said liquid, which is discharged via a low-pressure steam outlet S31, the vaporization of the liquid being at least partially achieved by the heat recovered from the waste steam flow by the heat recovery assembly 30,
a mechanical steam compression system 32, comprising one or more mechanical compression stages, each preferably comprising a compressor Cop ensuring the compression of the low-pressure steam into high-pressure steam which is conveyed to the drying steam inlet E2 of the drying enclosure of the dryer 2.

The heat recovery and steam generation system 3 advantageously reduces the consumption of energy for supplying the dryer with drying steam, preferably based on electrical energy.

The devices of the system 3 (in particular circulation pumps, valves, possibly heat pumps, including the mechanical compression stage(s)) are electrical devices.

It is possible that during operation, the drying steam generated by the heat recovery system 3 may not be sufficient to cover the requirements of the dryer 2 in transient states, for example at dryer start-up, or even during steady-state operation. An independent steam source SV (i.e., not generated by the system 3) ensures that the dryer's drying steam requirements are met at start-up, or even during steady-state operation if supplementation is necessary.

Generally, some or all of the liquid to be vaporized Lv comes from a condensate Cvap resulting from condensation of the drying steam VS which has transferred its heat to the products through the wall according to the first possibility, or some or all of the liquid to be vaporized comes from a condensate Cvap resulting from condensation of the drying steam which has transferred its heat to the drying air according to the second possibility. A pipe C1 may convey the condensate Cvap to the steam generation system 31.

In general, the compression stages may provide a compression ratio that is strictly greater than 1 inclusive, and advantageously a compression ratio greater than 10, for example between 10 and 50. The number of compressors in series may typically be between 3 and 20, and for example between 5 and 10, 18, etc., to allow a compression ratio greater than 10, or even greater than 20. If the generated low-pressure steam is at 80° C., the electric compression stages can compress it up to 200° C. (i.e., a compression ratio of 33), and for example between 150° C. and 200° C.

By way of non-limiting example, the dryer 2 may be chosen in particular among:
a spray tower for which the drying enclosure is equipped with a system for spraying a suspension to be dried by direct contact with hot air; the drying steam heats cold air (e.g. air at ambient temperature) to hot air through a wall (indirect heat exchange). The hot air is mixed with the product to be sprayed, for example via a dual-fluid nozzle that receives both the hot air and the product to be sprayed.
a rotary dryer comprising a rotating drum that receives the products internally, configured to ensure that the products are stirred during drying and that drying air circulates inside the drum, typically counter-current to the dried products.
a rotary dryer that receives the drying steam internally, with the dried product being on the drum's outer surface so that the heat exchange occurs through the drum wall.
a belt dryer comprising a conveyor belt supporting the products and ensuring the advancement of the products through the drying enclosure.
a flash dryer with an inlet at the base of a column for the products to be dried, the products being dispersed by an upward flow of hot air in the column, carrying the products along, the hot drying air AS being obtained by heating air with the drying steam VS, typically through a wall (indirect heat exchange).
a fluid bed dryer comprising, in the drying enclosure, a distributor plate which hot air (drying air) flows through, the products suspended by the vertical flow forming a fluid bed, the hot air being obtained by heating air with the drying steam, typically through a wall (indirect heat exchange)

The drying steam VS is steam that is saturated or supersaturated in order to ensure a heat exchange between the products and the drying steam through a wall, or to heat air, through a wall, which is fed into the heating chamber in order to heat the products directly. The drying air AS has a humidity level that is far below the steam saturation point and can therefore absorb moisture from the products in the drying enclosure before exiting through the outlet S2. When the drying air comes into direct contact with the products while drying in the dryer 2, the drying air may become laden with dust from the products.

By way of non-limiting example, the dryer 2 may be a rotary shaft dryer comprising a cylindrical body inside which a rotor shaft with arms rotates. The rotation of the rotor stirs the products inside the drying enclosure, as well as advancing them along the axis of the cylindrical body, from an inlet to an outlet. The drying air typically circulates counter-currently to the products in the dryer.

Generally, and according to a first possibility and as illustrated in FIGS. 1, 2, 3, 4, 6, 7, 8, the condensate is a liquid that is distinct from the liquid to be vaporized. Specifically, the steam generation system uses a source of liquid such as tap water and/or a condensate Cvap from the condensation of the drying steam VS (which is clean and dust-free), and not the condensate Ca from the condensation of the waste steam, which typically can be laden with dust. The steam generation system 31 for example preferably uses the condensate Cvap from the condensation of the drying steam, and supplements this with a source of liquid such as tap water.

Generally, and according to a second possibility and as illustrated in FIG. 5, the steam generation system may use as a source of liquid the condensate Ca from condensation of the waste steam, taking advantage of the enthalpy of the still-hot condensate, which is higher than the vaporization temperature of the steam generation system 31, and/or the condensate Cvap from condensation of the drying steam, and in particular a source of liquid such as tap water to supplement.

Generally, the facility may comprise a control and regulation unit for the compression system, comprising a microprocessor, memory, and a set of instructions configured to control the frequency and/or speed of some or all of the compressors Cop, to ensure several different operating ranges of the dryer.

The operating phases of the dryer may include the dryer's increase in temperature during start-up, in particular a transient state; or a steady-state; or even dryer shutdown.

The control unit and instructions may also allow controlling at least one control valve VR of at least one bypass loop Bcl to recirculate the drying steam from the downstream compressor(s), in particular to ensure a minimum flow rate in the compressor(s). Also, when the steam flow rate is too low in some or all of the compressors, after one or more phases of the dryer, the control valve ensures a recirculation of the drying steam in order to increase the flow rate in the compressors. Although the figure illustrates a single bypass loop controlled by one control valve, there may be several independent control loops, preferably controlled independently by several control valves.

Generally, some or all of the rotors of the compressors Cop may include a return-prevention system, protecting the compression devices from a sudden influx of countercurrent steam, thus preventing damage. The return-prevention system may be a hook and ratchet type of system. The hooks (or teeth) are distributed around the periphery of a wheel. The ratchet typically engages with the hooks (or teeth) which are pressed against it by a spring. The geometries of the teeth/hooks and of the ratchet are configured so that the ratchet slides on the periphery of the wheel in the permitted direction of rotation, the hook being configured to engage with one of the teeth on the periphery of the wheel when the direction of rotation is in the opposite direction, to prevent this reverse direction.

According to a first embodiment, illustrated by way of example in FIG. 1, the heat recovery assembly 30 and the steam generation system 31 are formed by a falling-film heat exchanger EFT.

The falling-film heat exchanger EFT comprises, within a sealed enclosure:
a set of vertical tubes having upper and lower openings, the vertical tubes extending in parallel within a sealed compartment CPT of the sealed enclosure,
an inlet, typically lateral, for the waste steam flow into the sealed compartment CPT, typically forming the inlet E30 configured so that the waste steam flow exchanges heat with the outer surfaces of the vertical tubes,
the liquid to be vaporized, which may come from a supply source such as tap water and/or from condensate Cvap, and is fed into an upstream upper chamber CHA of the sealed compartment that is open to the upper openings of the tubes, such that gravity causes the liquid to be vaporized to flow and trickle inside the tubes, on the inside surfaces of the tubes, vaporizing a portion of the liquid due to the transfer of heat from the waste steam, and the unvaporized portion of the liquid exiting through the lower openings of the tubes and collected in a downstream lower chamber CHV.
an outlet, typically lateral, to the sealed compartment, forming the outlet S31, in particular the downstream or upstream chamber for the low-pressure steam generated inside the tubes.

A recirculation pump PR recirculates the liquid collected in the downstream chamber CHV, which is recycled into the upstream chamber CHA, typically continuously.

The waste steam, having transferred its heat to the liquid Lv via the tubes, condenses in the sealed compartment CPT, which has a lateral outlet forming the outlet S30c for the condensate, as well as the outlet S30nc for the non-condensables.

Such a solution according to the first embodiment is particularly useful when the waste steam flow at the inlet of the falling-film heat exchanger is carrying little dust, and offers the following advantages:
a When the waste steam or vapors S2 contain a non-fouling volatile element other than water (ethanol, for example), this prevents the condensate Ca and the liquid to be vaporized Lv from mixing together, the non-fouling volatile element (ethanol) being recovered as condensate,
b This solution offers good heat transfer (better than when there is a heat exchanger EG) despite the presence of air, which hinders heat exchanges.

Such a solution further optimizes the footprint: the falling-film heat exchanger comprises a single vertical body integrating two chambers (heat exchanger+vaporizer).

According to one or more embodiments, illustrated in particular by the examples in FIGS. 3, 4, 5, and 8, the heat recovery assembly 30 comprises a mixing condenser CD including a condensation chamber inside which the waste steam flow condenses into the condensate Ca by direct exchange with the condensate, which is collected in the bottom via an outlet from the mixing condenser CD, cooled outside the condenser, and recycled in the top of the condensation chamber via an inlet into the condensation chamber, for example by being sprayed or misted into the top of the condensation chamber. The outlet in the bottom forms the outlet 30c for the condensate Ca, the condensation chamber having an outlet in the top forming the outlet for the non-condensables S30nc.

The condensation chamber has the inlet E30 for waste steam, typically located in the bottom of the condensation chamber. The cold liquid, namely the recycled condensate, is sprayed/misted into the top of the condensation chamber and mixes with the waste steam to ensure condensation of the steam as it falls.

Fins or plates/spillways within the condensation chamber allow intercepting the cold liquid that falls into the condensation chamber due to gravity and to divert it, to ensure uniformity of the mixture within the volume of the condensation chamber.

In general, such a mixing condenser for condensing waste steam VF is compatible with waste steam laden with dust, as it is an easily cleanable device: it can be particularly useful when the waste steam is laden with dust, typically having exchanged heat with the products directly, and in particular according to the embodiments of FIGS. 3, 4, and 5 for which the devices recovering heat from the condensate are compatible with condensates laden with dust.

According to one embodiment, in particular as shown in FIGS. 3, 4, and 8, the condensate is a liquid that is distinct from the liquid to be vaporized, the liquid to be vaporized Lv and the condensate Ca not being mixed. The heat recovery assembly 30 comprises a heat transfer device, comprising at least one heat exchanger EG and/or a heat pump system PAC, configured to extract heat from the condensate and cool it before recirculating the cooled condensate to the condenser, and to transfer the heat extracted from the condensate to the liquid to be vaporized Lv in order to reheat it. The source of the liquid to be vaporized may be tap water and/or the condensate Cvap from drying steam conveyed through the pipe C1 to the circuit containing the liquid to be vaporized.

According to one embodiment, in particular as shown in FIGS. 3, 4, and 8, the steam generation system 31 comprises or is formed by a vaporization device configured to spray and partially vaporize, into said low-pressure steam, the liquid to be vaporized Lv that has been heated by heat extracted from the condensate Ca in a vaporization enclosure EV via an inlet into the vaporization enclosure EV, by means of a sudden drop in the pressure of the liquid, a portion of the liquid to be vaporized being recovered in the bottom of the vaporization enclosure through an outlet.

The condensate Cvap may be conveyed via the pipe C1 directly to the inlet to the vaporization enclosure EV.

Generally, the liquid recovered in the bottom of the vaporization device can be reheated by heat recovered by the heat recovery assembly 30 and reintroduced at the inlet to the vaporization chamber.

According to one embodiment, illustrated in particular in FIG. 4, the heat transfer device includes the heat exchanger EG comprising:
a primary side, through which the condensate Ca flows, recirculated from the outlet of the mixing condenser CD to the inlet of the mixing condenser CD,
a secondary side, through which the liquid to be vaporized Lv flows, recirculated from the outlet at the bottom of the vaporization enclosure EV to the inlet of the vaporization enclosure,
   and wherein the heat transfer occurs through a wall of the heat exchanger EG. A heat exchanger EG may be chosen that can carry dust-laden condensate, namely in which the primary side through which the condensate flows can be easily cleaned.

According to one embodiment, illustrated in a non-limiting manner in FIG. 3, the heat transfer device comprises a heat exchanger EG and a heat pump PAC.

In particular, and with reference to FIG. 3, the heat exchanger comprises:
a primary side, through which the condensate Ca flows, recirculated from the outlet of the mixing condenser CD to the inlet of the mixing condenser CD,
a secondary side, through which a loop of transfer fluid FT flows, the transfer fluid flowing through the secondary side of the heat exchanger EG, by heat recovered from heat extracted from the condensate flowing through the primary side of the heat exchanger, a pump ensuring the circulation of fluid in the loop.

In a manner that is known per se, the heat pump PAC comprises a coolant circuit, the circuit comprising an evaporator and a condenser. A compressor circulates the coolant to the evaporator so that the liquid-state coolant evaporates in the evaporator, absorbing heat from the transfer fluid FT. The gaseous-state coolant is compressed in the compressor and then condenses in the condenser, transferring heat to the liquid to be vaporized Lv, which is recirculated from the outlet in the bottom of the vaporization enclosure to the inlet of the vaporization enclosure EV. This embodiment, illustrated in FIG. 3, is particularly useful when the waste steam flow has a low moisture content (i.e., a high air content), typically at a temperature below 80° C. The heat pump raises the temperature of the liquid to be vaporized to a temperature suitable for vaporization by abruptly creating negative pressure in the vaporization enclosure. On the other hand, the heat extracted from the condensate Ca by the heat pump is extracted only via the heat exchanger EG, so that the condensate does not directly attack the heat pump PAC, which is therefore protected from any dust contained in the condensate.

According to another embodiment, in particular illustrated in FIG. 8, the heat transfer device comprises a heat pump PAC comprising a coolant circuit which includes:
an evaporator extracting heat from the condensate Ca recirculated from the outlet of the mixing condenser CD to the inlet of the mixing condenser CD, and
a condenser transferring heat to the liquid to be vaporized which is recirculated from the outlet in the bottom of the vaporization enclosure EV to the inlet of the vaporization enclosure EV.

A compressor circulates the coolant to the evaporator so that the liquid-state coolant evaporates at the evaporator, absorbing heat from the condensate Ca. The gaseous-state coolant is compressed by the compressor and then condenses at the condenser, transferring heat to the liquid to be vaporized Lv, which is recirculated from the outlet in the bottom of the vaporization enclosure to the inlet of the vaporization enclosure EV. This embodiment, illustrated in FIG. 8, is particularly applicable when the waste steam flow has a low moisture content (i.e., a high air content), the waste steam flow typically being at a temperature below 80° C. The heat pump PAC raises the temperature of the liquid to be vaporized to a temperature that is compatible with its vaporization by abruptly creating negative pressure in the vaporization enclosure.

On the other hand, the heat extracted from the condensate Ca by the heat pump is extracted directly, so that the condensate directly attacks the heat pump. However, such an embodiment is not suitable for a waste steam flow that is laden with dust: indeed, unlike the embodiment in FIG. 3, and according to the embodiment in FIG. 8, the heat pump is therefore not protected from any dust contained in the condensate.

According to one embodiment, in particular in FIG. 5, the liquid to be vaporized Lv, heated by the heat, is the condensate Ca recovered at the bottom outlet from the mixing condenser CD. This condensate is sprayed and partially vaporized into said low-pressure steam in a vaporization enclosure, via an inlet, by means of a sudden pressure drop. A portion of the liquid to be vaporized is recovered at the bottom of the vaporization enclosure via an outlet and recycled back to the inlet of the mixing condenser CD, typically by a recirculation pump. Such an embodiment is particularly applicable even when the drying steam flow is laden with air. This solution, which lacks a heat exchanger and/or heat pump, is particularly advantageous with respect to efficiency and the minimization of electricity consumption compared to the other embodiments.

According to another embodiment, illustrated in FIG. 2, the heat recovery assembly 30 comprises a plate heat exchanger EG and a heat pump PAC, and the steam generation system comprises a vaporization device including the vaporization enclosure EV.

The plate heat exchanger EG comprises:
a primary side, through which the waste steam flow passes,
a secondary side, through which a transfer fluid FT from a loop of circulating fluid passes.

The heat exchanger is configured to transfer heat from the primary side, by extracting heat from the waste steam flow, to the secondary side in order to heat the transfer fluid FT via one or more plates of the exchanger.

The heat pump PAC comprises a coolant circuit that includes an evaporator extracting heat from the transfer fluid FT of the fluid loop and a condenser transferring heat to the liquid to be vaporized Lv. A compressor circulates the coolant to the evaporator so that the liquid-state coolant evaporates in the evaporator by absorbing heat from the transfer fluid FT, the gaseous-state coolant being compressed in the compressor and then condensing in the condenser while transferring heat to the recirculated liquid to be vaporized Lv. This liquid is recirculated from the outlet in the bottom of the vaporization enclosure to the inlet of the vaporization enclosure EV. The vaporization device comprises a vaporization chamber EV with an inlet for the heated liquid to be vaporized Lv, which is sprayed and partially vaporized within the vaporization chamber EV by a sudden drop in the pressure of the liquid. The unvaporized portion of the liquid to be vaporized falls to the bottom of the chamber and is collected via an outlet ensuring recirculation of the liquid to be vaporized back to the condenser of the heat pump PAC.

According to another embodiment, illustrated in particular in FIG. 7, the steam generation system may include a heat exchanger and a vaporization device.

This heat exchanger is a spray-cooled tube heat exchanger EFA comprising, within a sealed enclosure:
a set of horizontal tubes having lateral openings at their ends, the horizontal tubes extending into a sealed compartment of the sealed enclosure,
an inlet for the waste steam flow into an upstream chamber CHA, arranged on one side of the sealed compartment and leading into the tubes, the upstream chamber being configured such that the waste steam flow passes through the tubes, exchanging heat with the inner surfaces of the tubes and condensing into a condensate Ca, and a downstream collection chamber CHV, which is open to the interior of the tubes, arranged on a second side of the sealed compartment, the downstream chamber being configured to collect the condensate Ca, having the outlet S30c for the condensates and the outlet S30nc for the non-condensables.

The compartment of the spray-cooled tube heat exchanger EFA includes an inlet for the liquid to be vaporized, in a top portion of the compartment, and a means for spraying the liquid to be vaporized onto the outer surfaces of the horizontal tubes in the compartment, configured to heat the liquid to be vaporized, the sealed compartment having an outlet for the liquid to be vaporized, heated by the heat extracted from the waste steam flow, in its bottom portion.

The vaporization device comprises a vaporization chamber EV having an inlet for the heated liquid to be vaporized Lv, which is sprayed and partially vaporized in the vaporization chamber EV by a sudden pressure drop, the unvaporized liquid to be vaporized falling to the bottom of the vaporization chamber and recovered via an outlet ensuring the recirculation of the liquid to be vaporized back to the inlet to the compartment of the spray-cooled tube heat exchanger EFA, typically by means of a recirculation pump. Such an embodiment, illustrated in FIG. 7, is compatible with a drying steam flow that is laden with dust, as the inside of the tubes can easily be cleaned, and offers very good efficiency, but is primarily suited for drying steam having a low air content.

According to an embodiment illustrated in particular in FIG. 6, the steam generation system comprises a heat exchanger which is a spray-cooled tube heat exchanger EFA, a heat pump PAC, and a vaporization device.

The spray-cooled tube heat exchanger EFA may comprise, within a sealed enclosure:
a set of horizontal tubes having lateral openings at their ends, the horizontal tubes extending into a sealed compartment of the sealed enclosure,
an inlet for the waste steam flow into an upstream chamber CHA arranged on one side of the sealed compartment and open to the interior of the tubes, the upstream chamber being configured such that the waste steam flow passes through the tubes, exchanging heat with the inner surfaces of the tubes and condensing into a condensate Ca, and a downstream chamber CHV, open to the interior of the tubes, arranged on a second side of the sealed compartment, the downstream chamber being configured to collect the condensate Ca and having the outlet for the condensates S30c and the outlet for the non-condensables S30nc.

The compartment of the heat exchanger comprises an inlet for a transfer fluid FT and a means for spraying a fluid onto the outer surfaces of the horizontal tubes in the compartment, configured to heat the transfer fluid FT, the sealed compartment having an outlet for the heated transfer fluid FT.

The heat pump PAC comprises a coolant circuit comprising an evaporator and a condenser, the evaporator being configured to extract heat from the transfer fluid FT which is then recirculated to the compartment's inlet for the transfer fluid, the condenser of the heat pump transferring heat to the liquid to be vaporized Lv.

The vaporization device comprises a vaporization enclosure EV having an inlet for the liquid to be vaporized Lv to be heated, which is sprayed and partially vaporized in the vaporization chamber by a sudden drop in the pressure of the liquid, the unvaporized liquid to be vaporized falling to the bottom of the vaporization chamber and being recovered via an outlet that ensures the recirculation of the liquid to be vaporized back to the condenser of the heat pump PAC, typically by a circulation pump. Such an embodiment, illustrated in FIG. 6, is compatible with a drying steam flow that is laden with dust, as the inside of the tubes can easily be cleaned, and offers very good efficiency. Furthermore, it is particularly suitable for drying steam with high air content, due to the operation of the heat pump PAC, unlike the embodiment in FIG. 7.

### INDUSTRIAL APPLICATION

These technical solutions can be particularly useful in the field of industrial drying.

This disclosure further relates to a method of drying which makes use of a drying facility according to this disclosure, in which the heat recovery and compressed steam generation facility recovers waste steam which is at a temperature between 10° C. and 100° C. and generates heating steam at a temperature between 80° C. and 220° C.

In the case of a direct heat exchange, drying air is generally used to dehydrate the products. In the case of an indirect heat exchange, saturated or supersaturated steam is generally used.

The products to be dried may be food or non-food products such as minerals, paper pulp, paint, or other items requiring a drying process.

### LIST OF REFERENCE SYMBOLS

1: Drying facility,
2: Dryer,
E2. Drying steam inlet,
S2. Waste steam outlet,
3. Heat recovery and drying steam generation system,
30. Heat recovery assembly,
S30c. Outlet for condensates,
S30nc. Outlet for non-condensables.
31. Steam generation system,
E31. Inlet for liquid to be vaporized,
S31. Outlet for low-pressure steam,
32. Mechanical steam compression system,
CD. Mixing condenser (FIGS. 3, 4, 5, and 8),
EFT. Falling-film heat exchanger (FIG. 1),
CPT. Compartment (receiving the vertical tubes of the falling-film heat exchanger)
EFA. Spray-cooled tube heat exchanger (FIGS. 6 and 7),
EG. Heat exchanger,
PAC. Heat pump (FIGS. 2, 3, and 6),
FT. Transfer fluid (loop between the heat exchanger and the heat pump in FIGS. 2, 3, and 6),
CHA. Upstream chamber (Falling-film heat exchanger as shown in FIG. 1 or spray-cooled tube heat exchanger as shown in FIGS. 6 and 7),
CHV. Downstream chamber (Falling-film heat exchanger as shown in FIG. 1 or spray-cooled tube heat exchanger as shown in FIGS. 6 and 7),
SV. Steam source,
Ca. Condensate,
Lv. Liquid to be vaporized
VS. Drying steam,
VF. Waste steam,
Co. Waste steam pipe,
Cvap. Condensate (drying steam),
C1. Pipe (condensate Cvap),
Cop. Compressors,
AS. Drying air.

1. A drying facility comprising:
/A/ a dryer having a drying enclosure and a drying steam inlet (E2), the drying steam (VS) being configured to exchange heat indirectly with products (P) to be dried within the drying enclosure, through a wall according to a first possibility, or alternatively the drying steam (VS) transfers its heat to a drying air (AS) supplied to the drying enclosure in order to dry the products by direct contact between the products and the drying air according to a second possibility, and a waste steam outlet (S2) for a waste steam flow (VF) which comes from drying the products, the waste steam being expressed from the products,
/B/ a heat recovery and drying steam generation system, comprising:
a pipe (Co) for recovering the waste steam flow,
a heat recovery assembly which is fed the waste steam flow conveyed by the pipe (Co), comprising an inlet (E30) for the waste steam flow conveyed by the pipe and a condensate outlet (S30c) for a condensate (Ca) and an outlet for non-condensables (S30nc),
a steam generation system comprising an inlet (E31) for a liquid to be vaporized (Lv) and ensuring the vaporization of said liquid which is discharged via a low-pressure steam outlet (S31), the vaporization of said liquid being achieved in whole or in part by the heat recovered from the waste steam flow (VF) by the heat recovery assembly,
a mechanical steam compression system, comprising one or more mechanical compression stages, each having a compressor (Cop) ensuring the compression of the low-pressure steam into a high-pressure steam which is conveyed to the drying steam inlet (E2) of the drying enclosure of the dryer.

2. The facility according to claim 1, wherein the liquid to be vaporized (Lv) comes in whole or in part from a condensate (Cvap) resulting from condensation of the drying steam (VS) that has transferred its heat to the products through the wall according to the first possibility, or alternatively the liquid to be vaporized comes in whole or in part from a condensate (Cvap) resulting from the condensation of drying steam that has transferred its heat to the drying air according to the second possibility, a pipe (C1) conveying the condensate (Cvap) to the steam generation system.

3. The facility according to claim 1, wherein the compression stages provide a compression ratio that is greater than 10, or even 20, for example between 10 and 50.

4. The facility according to claim 1, comprising:
a control and regulation unit for the compression system, comprising a microprocessor, memory, and a set of instructions configured to control the frequency and/or speed of some or all of the compressors, in order to provide several different operating ranges of the dryer, and to control at least one control valve (VR) of at least one bypass loop (Bcl) ensuring a recirculation of the drying steam from the upstream compressor(s) while ensuring a minimum flow rate in the compressor(s).

5. The facility according to claim 1, wherein the condensate (Ca) that comes from the condensation of waste steam (VF) is a liquid that is distinct from the liquid to be vaporized, and the heat recovery assembly and the steam generation system are formed by a falling-film heat exchanger (EFT) comprising, within a sealed enclosure:
a set of vertical tubes having upper and lower openings, the vertical tubes extending in parallel within a sealed compartment (CPT) of the sealed enclosure,
an inlet for the waste steam flow (VF) into the sealed compartment, configured such that the waste steam flow exchanges heat with the outer surfaces of the vertical tubes,
the liquid to be vaporized (Lv), coming from a supply source and/or from condensation of the drying steam when the facility is in accordance with claim 2, and fed into an upstream upper chamber (CHA) that is open to the upper openings of the tubes, such that gravity causes the liquid to flow inside the tubes, vaporizing a portion of the liquid due to the transfer of heat from the waste steam, and an unvaporized portion of the liquid exiting through the lower openings of the tubes and recovered in a downstream lower chamber (CHV);
a recirculation pump (PR) which recirculates the liquid recovered in the downstream chamber (CHV), recycling it into the upstream chamber (CHA),
an outlet (S31) for the low-pressure steam generated inside the tubes.

6. The facility according to claim 1, wherein the heat recovery assembly comprises a mixing condenser (CD) which has a condensation chamber within which the waste steam flow (VF) condenses into condensate (Ca) by a direct heat exchange with the condensate (Ca), which is collected at the bottom via an outlet from the mixing condenser (CD), cooled outside the condenser, and recycled for spraying or misting at the top of the condensation chamber via an inlet into the condensation chamber.

7. The facility according to claim 6, wherein the condensate is a liquid that is distinct from the liquid to be vaporized, the liquid to be vaporized (Lv) and the waste steam condensate (Ca) not being mixed, the heat recovery assembly including a heat transfer device comprising at least one heat exchanger (EG) and/or a heat pump system (PAC), configured to: extract heat from the condensate (Ca) and cool it before recirculating the cooled condensate to the condenser, and transfer the heat extracted from the condensate to the liquid to be vaporized (Lv) in order to reheat it.

8. The facility according to claim 7, wherein the steam generation system comprises a vaporization device configured to spray and partially vaporize, into the low-pressure steam, the liquid to be vaporized (Lv) which has been heated by the heat extracted from the condensate (Ca) in a vaporization enclosure (EV) via an inlet to the vaporization enclosure (EV), by an abrupt drop in the pressure of the liquid, a portion of the liquid to be vaporized being recovered from the bottom of the vaporization enclosure via an outlet.

9. The facility according to claim 8, wherein the heat transfer device includes the heat exchanger (EG) which comprises:
a primary side, through which the waste steam condensate (Ca) flows as it recirculates from the outlet of the mixing condenser (CD) to the inlet of the mixing condenser (CD),
a secondary side, through which the liquid to be vaporized (Lv) flows, recirculated from the outlet in the bottom of the vaporization enclosure (EV) to the inlet of the vaporization enclosure,
and wherein the heat transfer occurs through a wall of the heat exchanger (EG).

10. The facility according to claim 8, wherein the heat transfer device comprises a heat exchanger and a heat pump,
the heat exchanger comprising:
a primary side, through which the condensate is recirculated from the outlet of the mixing condenser (CD) to the inlet of the mixing condenser (CD),
a secondary side, through which a loop of recirculated transfer fluid circulates,
and wherein the heat transfer occurs through a wall of the heat exchanger (EG),
the heat pump (PAC) comprising a coolant circuit including an evaporator and a condenser, the condenser extracting heat from the recirculated transfer fluid, and the condenser transferring heat to the liquid to be vaporized (Lv) that is recirculated from the outlet in the bottom of the vaporization enclosure to the inlet of the vaporization enclosure (EV).

11. The facility according to claim 8, wherein the heat transfer device comprises a heat pump (PAC) comprising a coolant circuit which includes:
an evaporator extracting heat from the condensate (Ca) that is recirculated from the outlet of the mixing condenser (CD) to the inlet of the mixing condenser (CD), and
a condenser transferring heat to the liquid to be vaporized (Lv) that is recirculated from the outlet in the bottom of the vaporization enclosure (EV) to the inlet of the vaporization enclosure (EV).

12. The facility according to claim 6 wherein the liquid to be vaporized (Lv), heated by the heat from the condensate (Ca) recovered at the bottom outlet of the mixing condenser (CD), is sprayed and partially vaporized into the low-pressure steam in a vaporization enclosure via an inlet, by means of a sudden pressure drop, a portion of the liquid to be vaporized being recovered in the bottom of the vaporization enclosure via an outlet and recycled back to the inlet of the mixing condenser (CD).

13. The facility according to claim 1, wherein the heat recovery assembly comprises a plate heat exchanger (EG) and a heat pump (PAC), and the steam generation system comprises a vaporization device, and wherein:
the plate heat exchanger (EG) comprises:
a primary side, through which the waste steam flow circulates,
a secondary side, through which a transfer fluid (FT) from a loop of circulating transfer fluid circulates,
the heat exchanger being configured to transfer heat from the primary side, by extracting heat from the waste steam flow, to the secondary side, in order to heat the transfer fluid (FT) by means of one or more plates of the exchanger,
and wherein the heat pump (PAC) comprises a coolant circuit including an evaporator that extracts heat from the transfer fluid (FT) of the circulation loop and a condenser that transfers heat to the liquid to be vaporized (Lv),
and wherein the vaporization device comprises a vaporization chamber (EV) having an inlet for the heated liquid to be vaporized (Lv) which is sprayed and partially vaporized in the vaporization chamber (EV) by a sudden drop in the pressure of the liquid, the unvaporized portion of the liquid to be vaporized then falling to the bottom of the chamber and being recovered via an outlet ensuring recirculation of the liquid to be vaporized back to the condenser of the heat pump (PAC).

14. The facility according to claim 1, wherein the steam generation system has a heat exchanger and a vaporization device,
and wherein the heat exchanger is a spray-cooled tube heat exchanger (EFA) comprising, within a sealed enclosure:
a set of horizontal tubes having lateral openings at their ends, the horizontal tubes extending into a sealed compartment of the sealed enclosure,
an inlet for the waste steam flow into an upstream chamber (CHA), arranged on one side of the sealed compartment and leading into the interior of the tubes, the upstream chamber being configured such that the waste steam flow passes through the tubes, exchanging heat with the inner surfaces of the tubes and condensing into a condensate (Ca), and a downstream collection chamber (CHV), which is open to the interior of the tubes, arranged on a second side of the sealed compartment, the downstream chamber being configured to collect the condensate (Ca) and having the outlet (S30c) for condensates and the outlet (S30nc) for non-condensables,
and wherein the compartment of the spray-cooled tube heat exchanger (EFA) includes an inlet for the liquid to be vaporized and a means for spraying the liquid to be vaporized onto the outer surfaces of the horizontal tubes in the compartment, configured to heat the liquid to be vaporized, the sealed compartment having an outlet for the heated liquid to be vaporized,
and wherein the vaporization device comprises a vaporization chamber (EV) having an inlet for the heated liquid to be vaporized (Lv), which is sprayed and partially vaporized in the vaporization chamber (EV) by a sudden pressure drop, the unvaporized liquid to be vaporized falling to the bottom of the vaporization chamber and being recovered via an outlet ensuring the recirculation of the liquid to be vaporized back to the inlet to the compartment of the spray-cooled tube heat exchanger (EFA).

15. The facility according to claim 1, wherein the steam generation system has a heat exchanger which is a spray-cooled tube heat exchanger (EFA), a heat pump (PAC), and a vaporization device,
and wherein the spray-cooled tube heat exchanger (EFA) comprises, within a sealed enclosure:
a set of horizontal tubes having lateral openings at their ends, the horizontal tubes extending into a sealed compartment of the sealed enclosure,
an inlet for the waste steam flow into an upstream chamber (CHA) arranged on one side of the sealed compartment and open to the interior of the tubes, the upstream chamber (CHA) being configured such that the waste steam flow passes through the tubes, exchanging heat with the inner surfaces of the tubes and condensing into a condensate (Ca), and a downstream chamber (CHV), open to the interior of the tubes, arranged on a second side of the sealed compartment, the downstream chamber being configured to collect the condensate (Ca) and having the outlet for condensates (S30c) and the outlet for non-condensables (S30nc),
and wherein the compartment of the heat exchanger has an inlet for a transfer liquid or transfer fluid (FT) and a means for spraying a liquid onto the outer surfaces of the horizontal tubes in the compartment, configured to heat the transfer fluid (FT), the sealed compartment having an outlet for the heated transfer fluid (FT),
and wherein the heat pump (PAC) comprises a coolant circuit including an evaporator and a condenser, the evaporator being configured to extract heat from the transfer fluid (FT) which is then recirculated to the compartment's inlet for the transfer fluid, the condenser of the heat pump transferring heat to the liquid to be vaporized (Lv),
and wherein the vaporization device comprises a vaporization chamber (EV) having an inlet for the heated liquid to be vaporized (Lv), which is sprayed and partially vaporized in the vaporization chamber by a sudden drop in the pressure of the liquid, the unvaporized liquid to be vaporized falling to the bottom of the vaporization enclosure and being recovered via an outlet that ensures the recirculation of the liquid to be vaporized back to the condenser of the heat pump (PAC).

16. The facility according to claim 1, according to the first possibility wherein the inlet (E2) for the drying steam is configured to ensure indirect drying of the products, through the wall of the drying enclosure.

17. The facility according to claim 1, according to the second possibility wherein the inlet (E2) for the drying steam is configured to heat air, via the wall, in the drying air (AS) supplied to the drying enclosure, in order to heat the products in the drying enclosure by direct contact between the drying air and the products.

18. The facility according to claim 17, wherein the dryer is selected among:
a spray tower for which the drying enclosure is provided with a system for spraying a suspension to be dried, having an inlet for drying air intended to be mixed with the products to be sprayed,
a rotary dryer comprising a rotating drum that receives the products internally, configured to ensure that the products are stirred during drying and that drying air circulates inside the enclosure containing the products,
a belt dryer comprising a conveyor belt supporting the products and ensuring the advancement of the products through the drying enclosure,
a flash dryer with an inlet at the base of a column for the products to be dried, the products being dispersed by an upward flow of drying air in the column which carries the products along,
a fluid bed dryer comprising, in the drying enclosure, a distributor plate which the drying air flows through, ensuring the creation of a fluid bed for the products.

19. A method of drying which makes use of a drying facility according to claim 1, wherein the heat recovery and compressed steam generation facility recovers waste steam which is at a temperature between 10° C. and 150° C., and generates heating steam at a temperature between 80° C. and 220° C.
